(19) United States
(12) Patent Application Publication
(10) Pub. No.: US 2024/0375131 A1
(43) Pub. Date: Nov. 14, 2024

(54) METHODS AND SYSTEMS FOR GENERATING AEROSPIKE DRY FOG NANOJET SPRAY

(71) Applicant: Innova NanoJet Technologies, Ltd, Dumbarton (GB)

(72) Inventors: Yankang TIAN, Glasgow (GB); Yi QIN, Glasgow (GB); Wenlong CHANG, Glasgow (GB); Sijun HE, Monrovia, CA (US); Chuantao WANG, Azusa, CA (US)

(21) Appl. No.: 18/780,978

(22) Filed: Jul. 23, 2024

Related U.S. Application Data
(63) Continuation of application No. PCT/US2024/025231, filed on Apr. 18, 2023.
(60) Provisional application No. 63/531,044, filed on Aug. 7, 2023.

(51) Int. Cl. B05B 7/06; B05B 7/10

(52) U.S. Cl. CPC B05B 7/066; B05B 7/10

(57) ABSTRACT

This application is directed to a spray device that is used as an aerospike dry fog nanojet spray device. The spray device includes a liquid channel, a gas channel, and an acoustic structure. The liquid channel is configured to transport a liquid flow, convert the liquid flow to a swirling liquid stream, and expel the swirling liquid stream via a first outlet. The gas channel further includes a tapered section coupled to a second outlet. The tapered section is configured to convert a gas flow to a supersonic gas jet to be released from the gas channel via the second outlet. The acoustic structure is configured to control spreading of a mixture of the supersonic gas jet and the swirling liquid stream and reduce a noise level of the spray device.

### RELATED APPLICATION

This application is a continuation of International Patent Application No. PCT/US24/25231, tilted “Methods and Systems for Generating Aerospike Dry Fog Nanojet Spray,” filed Apr. 18, 2024, which claims priority to U.S. Provisional Application No. 63/531,044, titled “Reduced-Noise Aerospike Dry fog Nanojet for Generating Spray with High Flow Rate and Ultrafine Droplet at Low Operation Pressure,” filed Aug. 7, 2023, which is incorporated by reference in its entirety.

### TECHNICAL FIELD

This application relates generally to spray devices, including but not limited to, methods and systems for generating aerospike dry fog sprays.

### BACKGROUND

Spray devices are widely applied to build mist generation systems in different applications. For example, a twin-fluid atomizing spray device includes a spray device body with two separate channels-one channel for liquid and one channel for gas, and has encountered challenges in achieving both high flow rates and ultrafine mist particles at low operation pressures. It is difficult for twin-fluid atomizing spray devices to consistently produce fine droplets and meet required effectiveness in various industries. Alternatively, a pre-filming spray device includes two air inlets (e.g., an inner air inlet and an outer air inlet) and one water inlet sitting between the air inlets. Water enters through the water inlet and flows through a narrow gap, forming a thin water sheet that is fragmented into water filaments and gets accelerated by an air stream from the inner air inlet. The mixture of water and air flows downstream and interacts with another air stream from the outer air inlet. The pre-filming spray device relies on a thin liquid film to generate fine droplets, thereby resulting in inconsistent droplet sizes. This inconsistency undermines precise control over spray characteristics, and affects effectiveness of the spray device and any associated mist generation systems. Furthermore, the pre-filming spray device is sensitive to properties of liquids being sprayed and can only be applied in limited applications.

### SUMMARY

Some implementations of this application are directed to an aerospike dry fog nanojet spray device, which utilizes aerospikes and supersonic air flows to generate trillions of high-speed and ultra-fine nano droplets (e.g., liquid mist) at a high flow rate and a low operation pressure. Liquid mist that is made of fine liquid droplets exhibits fine droplet sizes in a nanometer or micrometer level. In particular, a large volume of liquid mist is generated at the high flow rate within a short duration of time to cover a large area efficiently and rapidly. In some implementations, the spray device further includes or is coupled to a three-dimensional serration structure (e.g., a serration edge, a chevron-shaped edge) at a spray device orifice to controlling noise produced during the course of generating the liquid mist by the spray device. By these means, the spray device can efficiently produce the high-speed and low-pressure liquid mist having fine droplet sizes to satisfy requirements of various applications (e.g., air purification, disinfection, sterilization, dust suppression, painting, fuel injection, material coating, and cooling) in different industries including, but not limited to, healthcare, agriculture, transport, construction, power generation industries, as well as domestic uses.

More specifically, in some implementations, the spray device produces ultrafine droplet sizes, mostly in nanometer ranges. Ultrafine droplets have a large surface-to-volume ratio, resulting in improved atomization and increased contact area with target surfaces. This boosts process efficiency for applications including coating, humidification, and pesticide. In some implementations, the spray device operates at a low operation pressure, which reduces energy consumption and operation costs of the spray device compared to many other spray devices using higher operation pressures. Low operation pressure minimizes risk of damaging delicate surfaces and/or materials, suitable for applications that require gentle handling. In some implementations, the spray device includes a three-dimensional serration structure configured to reduce noise generated during atomization process. The serration structure further includes streamwise vortices coupled in a shear layer between a high-speed spray device flow and a slow ambient air flow. The serration structure smooths and disrupts a flow of the liquid mist, thereby reducing both turbulence in the flow and noise produced by the turbulence and enhancing user experience of the spray device with a quieter operation environment.

In various implementations of this application, the spray device operates with a combination of a high flow rate, an ultrafine droplet size, and a low operation pressure, thereby providing aerospike flow patterns, which allows for a faster and more comprehensive space coverage, reduced material waste, enhanced spray quality, and improved process performance. Application of such a spray device improves efficiency and effectiveness of generation of a mixture of liquid and gas.

In one aspect of the application, a spray device includes a first housing structure, a second housing structure, and a gas channel. The first housing structure includes a liquid channel. The liquid channel is configured to transport a liquid flow, convert the liquid flow to a swirling liquid stream, and expel the swirling liquid stream out of the first housing structure via a first outlet. The second housing structure surrounds the first housing structure. The gas channel is formed between the first housing structure and the second housing structure. The gas channel further includes a tapered section coupled to a second outlet. The tapered section has a varying width that decreases continuously with respect to an extended section length. The tapered section is configured to convert a gas flow to a supersonic gas jet to be released from the gas channel via the second outlet.

In another aspect of the application, a method is implemented to provide a spray device. The method includes providing a first housing structure including a liquid channel, and the liquid channel is configured to transport a liquid flow, convert the liquid flow to a swirling liquid stream, and expel the swirling liquid stream out of the first housing structure via a first outlet. The method further includes providing a second housing structure surrounding the first housing structure and providing a gas channel formed between the first housing structure and the second housing structure. The gas channel further includes a tapered section coupled to a second outlet. The tapered section has a varying width that decreases continuously with respect to an extended section length, and is configured to convert a gas flow to a supersonic gas jet to be released from the gas channel via the second outlet.

In yet another aspect of the application, a method is implemented by a spray device for generating nanojet spray. The method includes transporting a liquid flow in a liquid channel of a first housing structure, converting the liquid flow to a swirling liquid stream, and expelling the swirling liquid stream out of the first housing structure via a first outlet of the liquid channel. The method further includes converting a gas flow to a supersonic gas jet to be released from a gas channel via a second outlet of the gas channel. The gas channel is formed between the first housing structure and a second housing structure that surrounds the first housing structure, and includes a tapered section coupled to the second outlet, and the tapered section has a varying width that decreases continuously with respect to an extended section length.

These illustrative aspects are mentioned not to limit or define the disclosure, but to provide examples to aid understanding thereof. Additional implementations are discussed in the Description of Implementations, and further description is provided there.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1A is a cross-section of a first example spray device of a mist generation system, in accordance with some implementations.

FIG. 1B is another cross-section of the first example spray device labeled with geometric parameters, in accordance with some implementations.

FIG. 2A is an exploded perspective view of a three-dimensional cross-section of a second example spray device, in accordance with some implementations.

FIG. 2B is a cross-sectional view of the three-dimensional cross-section of the second example spray device, in accordance with some implementations.

FIG. 2C illustrates a perspective view, a top view, and a bottom view of a swirling component, in accordance with some implementations.

FIG. 3 is a flow diagram of an example method of providing a spray device, in accordance with some implementations.

Like reference numerals refer to corresponding parts throughout the several views of the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Some implementations of this application are directed to an aerospike dry fog nanojet spray device configured to generate ultrafine droplets at a high flow rate and a low inlet pressure, e.g., without use of moving components. The nanojet spray device may be streamlined, such that the streamlined nanojet spray device may reduce pressure required for atomizing liquid. The streamlined nanojet spray device generates an aerospike near an outlet of the spray device, allowing an initial droplet breakup. In some situations, a supersonic air flow is induced surrounding the aerospike, resulting in a secondary droplet breakup and atomizing the liquid into micro-sized or nano-sized mist droplets. The mist droplets are then expelled through the spray device, forming a high-flow dry mist. Further, in some implementations, the spray device is used along with an acoustic structure (e.g., an acoustic shield with a three-dimensional serration structure). The acoustic structure smooths a mixture of a high-speed flow expelled out of the spray device and a slow ambient air flow, e.g., by introducing streamwise vortices into a shear layer, and effectively reduces a noise level of the spray device without compromising performance of the spray device on mist generation.

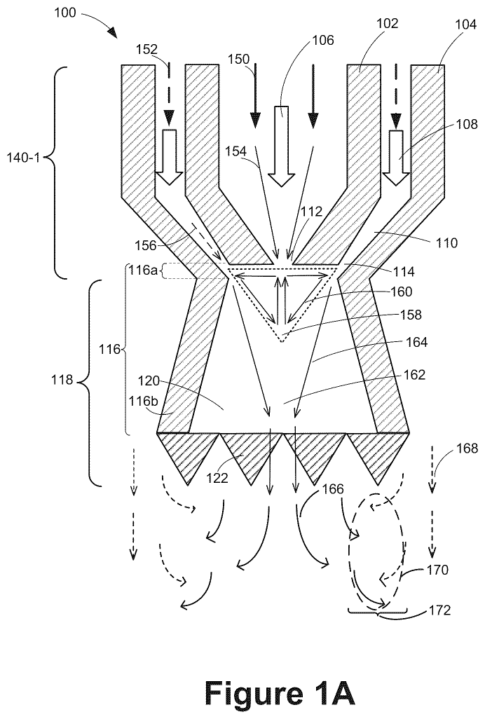

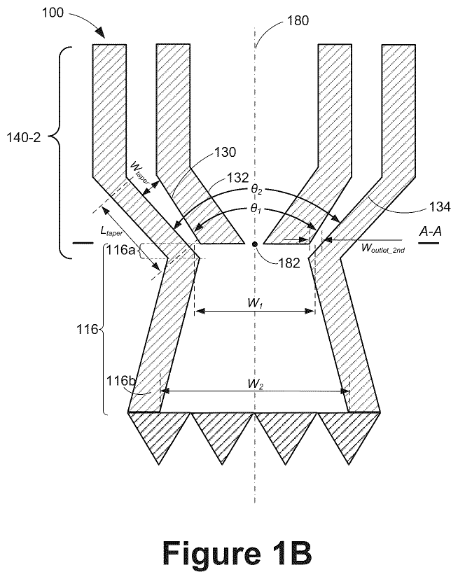

FIG. 1A is a cross-section 140-1 of a first example spray device 100 of a mist generation system, in accordance with some implementations, and FIG. 1B is another cross-section 140-2 of the first example spray device 100 labeled with geometric parameters, in accordance with some implementations. The first example spray device 100 represents one implementation of an aerospike dry fog nanojet spray device. The first example spray device 100 includes a first housing structure 102 and a second housing structure 104. The first housing structure 102 includes a liquid channel 106 (e.g., a streamlined liquid channel). The liquid channel 106 is configured to transport a liquid flow 150 (e.g., received from a liquid inlet), convert the liquid flow 150 to a swirling liquid stream 154, and expel the swirling liquid stream 154 out of the first housing structure 102 via a first outlet 112. The second housing structure 104 surrounds the first housing structure 102. A gas channel 108 (e.g., a streamlined gas channel) is formed between the first housing structure 102 and the second housing structure 104. The gas channel 108 further includes a tapered section 110 coupled to a second outlet 114. The tapered section 110 has a varying taper width (Wₜₐₚₑᵣ) that decreases continuously with respect to an extended section length (Lₜₐₚₑᵣ). The tapered section 110 is configured to convert a gas flow 152 (e.g., an air inlet) to a supersonic gas jet 156 to be released from the gas channel 108 via the second outlet 114. In some implementations, the first housing structure 102 and the second housing structure 104 are coupled to one another using threaded connections.

In some implementations, the extended section length (Lₜₐₚₑᵣ) of the tapered section 110 of the gas channel 108 is in a predetermined length range. The taper width (Wₜₐₚₑᵣ) of the tapered section 110 of the gas channel 108 is in a predetermined width range. A volumetric flow rate of the gas channel 108 is in a predetermined flow rate range. In some implementations, the predetermined length range is greater than 1 mm. The predetermined width range is greater than 0.01 mm. The predetermined flow rate range is greater than 10 liters per minute (L/min). In some implementations, the extended section length (Lₜₐₚₑᵣ) of the tapered section 110 is configured to vary with a target flow rate associated with the gas channel 108. In some implementations, the liquid flow 150 and/or the gas flow 152 are mixed to form a converging aerospike mixture, and a droplet size of liquid droplets of the mixture is in a range of 0.05-50 μm. Conversely, in some situations, the droplet size (e.g., a diameter) of liquid droplets of the mixture is below 50 nm (e.g., equal to 10 nm or below).

In some implementations, the spray device 100 has a plurality of cross sections that are perpendicular to, and intersect with, a central axis 180 (FIG. 1B). Each cross section is symmetric with respect to a respective intersecting node with the central axis 180. In one example, a cross-section A-A, which cuts through an area near the first outlet 112 and the second outlet 114, is symmetric with respect to an intersecting node 182 with the central axis 180. In some implementations, the first housing structure 102 and the second housing structure 104 are substantially cylindrically symmetric along the central axis 180.

In some implementations, an external surface 130 of the first housing structure 102 is conical and has a first opening angle (θ₁), and an internal surface 134 of the second housing structure 104 is conical and has a second opening angle (θ₂) greater than the first opening angle (θ₁). For instance, the first opening angle (θ₁) is in a first predefined range, and the second opening angle (θ₂) is in a second predefined range

In some implementations, the gas channel 108 is formed between the external surface 130 of the first housing structure 102 and an internal surface 134 of the second housing structure 104. The gas channel 108 is configured to increase a gas flow speed of the gas flow 152. For instance, the taper width (Wₜₐₚₑᵣ) of the tapered section 110 varies and decreases continuously with respect to the extended section length (Lₜₐₚₑᵣ). This structure allows the tapered section 110 to convert the gas flow 152 to the supersonic gas jet 156, such that the gas flow speed of the gas flow 152 is enhanced through the tapered section 110.

In some implementations, the second outlet 114 of the gas channel 108 has a ring shape and substantially surrounds the first outlet 112 of the liquid channel 106. This is because the first housing structure 102 and the second housing structure 104 can be substantially cylindrically symmetric. In some implementations, a width (W_{outlet_2nd}) of the second outlet 114 of the gas channel 108 is in a predetermined width range. In some implementations, the predetermined width range can be greater than 0.01 mm. In some implementations, the width (W_{outlet_2nd}) of the second outlet 114 of the gas channel 108 is subject to design specifications (e.g., mechanical designs, airflow dynamics, etc.).

The first example spray device 100 further includes an aerospike zone 158 coupled immediately adjacent to both the first outlet 112 of the liquid channel 106 and the second outlet 114 of the gas channel 108. The aerospike zone 158 is configured to receive the swirling liquid stream 154 and the supersonic gas jet 156 and form a converging aerospike mixture 160. As shown in FIG. 1, the expelled swirling liquid stream 154 and the expelled supersonic gas jet 156 circulate at a high flow speed in the aerospike zone 158 with respect to airflow dynamics, such that the aerospike zone 158 takes on form of an aerospike.

In some implementations, a droplet size of liquid droplets (e.g., ultrafine droplets) of the converging aerospike mixture is in a range of 0.05-50 micrometer (μm). Conversely, in some situations, the droplet size (e.g., a diameter) of liquid droplets of the mixture is below 50 nm (e.g., equal to 10 nm or below).

In some implementations, the second housing structure 104 further includes an expansion portion 116 that extends beyond the second outlet 114 of the gas channel 108. The expansion portion 116 is configured to constrain the converging aerospike mixture 160 in the aerospike zone 158 adjacent to the first outlet 112 of the liquid channel 106 and the second outlet 114 of the gas channel 108. Specifically, the expansion portion 116 is formed such that a width (W₁) of a top portion 116a of the expansion portion 116 is narrower than a width (W₂) of a bottom portion 116b of the expansion portion 116. The expansion portion 116 gradually narrows in the top portion 116a and expands within the bottom portion 116b, thereby constraining the converging aerospike mixture 160 in the aerospike zone 158.

The first example spray device 100 further includes an acoustic structure 118 coupled to the second housing structure 104. The acoustic structure 118 is configured to create a streamlined conical coaxial gas channel 120, control spreading of a mixture of the supersonic gas jet 156 and the swirling liquid stream 154, and reduce a noise level of the first example spray device 100. In some implementations, the acoustic structure 118 further includes a supersonic zone 162. The converging aerospike mixture 160 in the aerospike zone 158 includes a supersonic liquid mist 164 flowing at a high flow rate (e.g., above a flow rate threshold) in the supersonic zone 162. The supersonic liquid mist 164 gets expelled from the acoustic structure 118. In some implementations, the supersonic liquid mist 164 includes a plurality of liquid droplets that have diameters in a nanometer level or in a micrometer level. For example, the diameters of the liquid droplets are 0.05-50 μm.

In some implementations, the streamlined conical coaxial gas channel 120 of the acoustic structure 118 optimizes airflow dynamics and promotes desired aerospike flow pattern. The supersonic liquid mist 164 is accelerated to a supersonic speed, forms the spray device flow 166 expelled from the acoustic structure 118, and turns into a vertex downstream. This facilitates efficient liquid atomization for generating ultrafine droplets.

In some implementations, the acoustic structure 118 has a serration edge 122. The serration edge 122 is a three-dimensional pattern and introduces streamwise vortices 170 into a shear layer 172 between the spray device flow 166 at a high flow rate and an ambient air flow 168 at a low flow rate. The spray device flow 166 is an output of the supersonic liquid mist 164 expelled from the acoustic structure 118. In particular, the streamwise vortices 170 disrupt and smooth the spray device flow 166, thereby reducing turbulence and noise generated during atomization. This brings benefits of maintaining a quiet working environment and improving user experience, addressing concerns related to occupational health and safety. In some implementations, the serration edge 122 is a chevron-shaped edge.

In some implementations, designs (e.g., geometries) of the first example spray device 100 including the acoustic structure 118 vary to achieve similar benefits. For instance, the acoustic structure 118 may include a curved or tapered gas channel instead of a conical coaxial gas channel. In another instance, the acoustic structure 118 utilizes alternative mechanisms to generate desired aerospike flow pattern and supersonic flow. In yet another instance, the first example spray device 100 includes alternative geometries for gas channels or alternative approaches for introducing streamwise vortices 170 into the shear layer 172 for noise reduction.

As discuss above, the aerospike dry fog nanojet spray device (e.g., a streamlined nanojet spray device) produces the aerospike zone 158, which includes the supersonic liquid mist 164 with fine liquid droplet sizes. The liquid flow 150 and the gas flow 152 are received at the liquid channel 106 and the gas channel 108 at a low pressure, while the supersonic liquid mist 164 is generated at a high flow rate. The first example spray device 100 uses a streamlined gas channel (e.g., the taper section 110 and the streamlined conical coaxial gas channel 120 of the acoustic structure 118) to generate the aerospike zone and the supersonic zone 162 surrounded by the acoustic structure 118. Such design sidesteps a need for use of extra intricate mechanical components within a single spray device assembly. This may eliminate the necessity for precision manufacturing under some circumstances.

Furthermore, the aerospike dry fog nanojet spray device featuring the acoustic serration structure (e.g., the serration edge 122) also provides additional functional benefits including, but not limited to, enhancing device efficiency, spray performance, handling of sensitive materials, versatility and adaptability, and occupational health and safety. First of all, for efficiency enhancement, the streamlined gas channel of the spray device generates the aerospike zone and the supersonic zone, and thus it enables the spray device to work at a low pressure. Specifically, the capability of producing sprays at a high flow rate with ultrafine droplets enhances efficiency across diverse applications. On one hand, this capability allows for faster and more comprehensive coverage of target surface, thereby reducing a total time required for spraying. On the other hand, this capability can also boost productivity and cut costs, particularly in applications that require treatment or coating of large areas and/or volumes.

Additionally, breaking up droplets involves two steps to improve spray performance. In an initial step, the spray device breaks the droplets from a water orifice (also called outlet) at a high turbulent flow in the aerospike zone. In a secondary step, the spray device further reduces droplet sizes with a supersonic flow to form ultrafine droplets. Spraying ultrafine droplets can enhance uniformity in coverage and bring superior adhesion to target objects, thereby minimizing risk of uneven distribution and/or missed areas. Consequently, mist generation systems aerospike dry fog nanojet spray devices can enhance energy efficiency, reduce material waste, and improve product performance in various applications including automotive painting, food processing, and building disinfection.

Further, for gentle handling of sensitive materials., the spray device supports a low operation pressure, thereby allowing for gentle handling of sensitive materials during spraying. Particularly, this capability adds values to industries including pharmaceuticals, food processing, and cosmetics, where delicate substances or heat-sensitive formulations are target objects to be sprayed. A gentle atomization process also mitigates risk of material degradation, safeguarding product integrity and quality. Moreover, the spray device further provides versatility and adaptability by way of generating sprays with ultrafine droplets (e.g., below I μm in diameter) that are injected into the ambient at a high flow rate. The spray device may use the serration structure for noise reduction. These capabilities ensure versatility and adaptability for various applications, including agriculture, healthcare, sanitation, and industrial manufacturing. These capabilities empower precise controls over spray characteristics tailored for specific application requirements and desired performance. Additionally, the spray device provides occupational health and safety. The serration structure for noise reduction addresses concerns related to occupational health and safety. This is because reducing noise levels would promote a safer operating environment and thus prevent potential hearing injuries for consumers. As such, the aerospike dry fog nanojet spray device is configured to operate at a low pressure to generate spray with ultrafine droplets at a high flow rate while creating litter or no noise, which brings advancements to spray technologies in a wide range of applications.

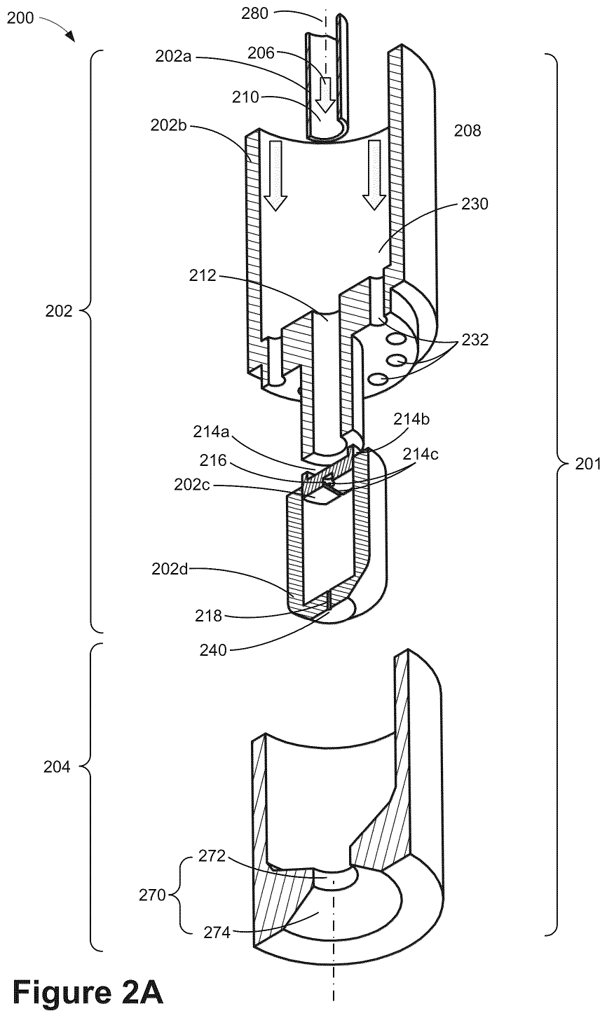

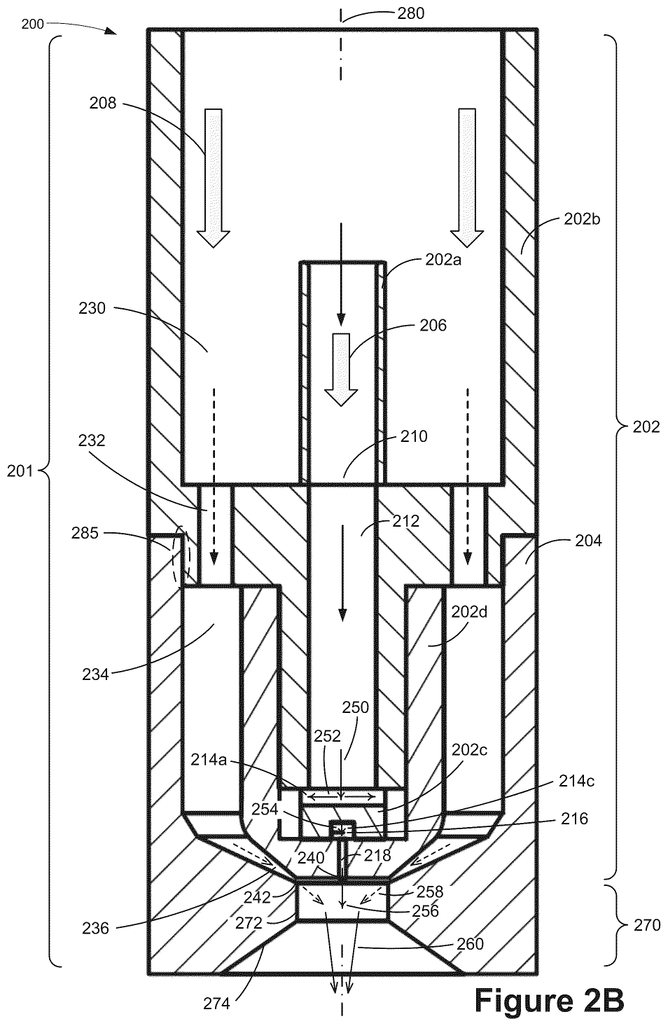

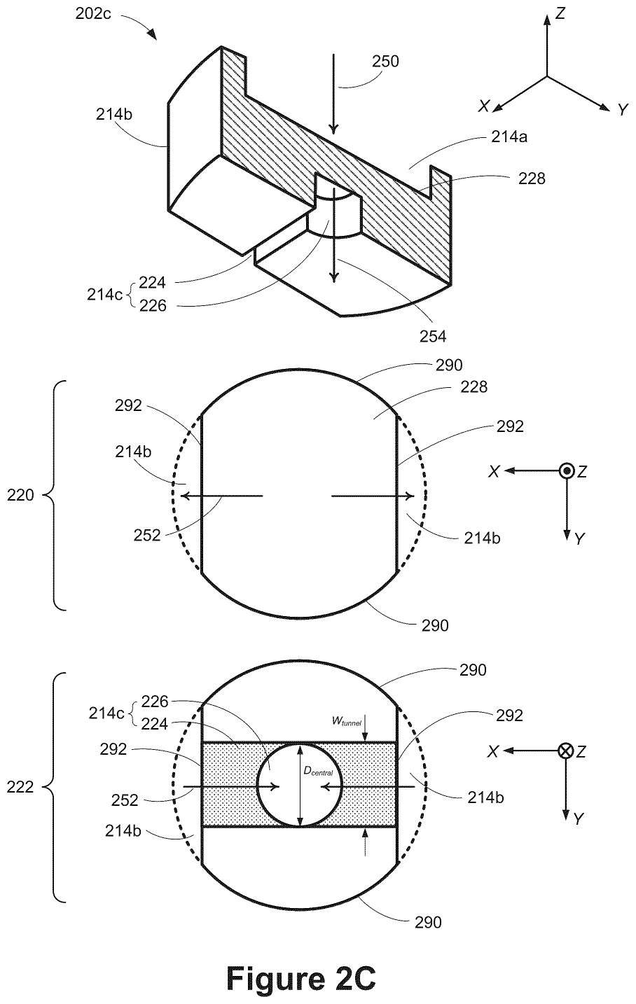

FIGS. 2A-2C illustrates a series of views of a second example spray device 200 of the mist generation system, in accordance with some implementations. FIG. 2A is an exploded perspective view of a three-dimensional cross-section 201 of the second example spray device 200, in accordance with some implementations. FIG. 2B is a cross-sectional view of the three-dimensional cross-section 201 of the second example spray device 200, in accordance with some implementations. FIG. 2C illustrates a perspective view, a top view, and a bottom view of a swirling component (e.g., 202c), in accordance with some implementations. Referring to FIG. 2A, in some implementations, the second example spray device 200 represents another implementation of the aerospike dry fog nanojet spray device. Similar to the first example spray device 100, the second example spray device 200 generates spray with controlled droplet sizes at a high flow rate. The second example spray device 200 includes a swirling component for generating a swirling liquid stream 254. The second example spray device 200 includes a first housing structure 202 and a second housing structure 204. The first housing structure 202 and the second housing structure 204 are symmetric with respect to a central axis 280 of the second example spray device 200. The first housing structure 202 further includes a connecting component 202a, a delivering component 202b, a swirling component 202c, and a central channel component 202d.

In some implementations, the second example spray device 200 includes separate channels for liquid and air. A liquid channel 206 (e.g., a streamlined liquid channel along the second example spray device 200) of the second example spray device 200 includes five sections (e.g., a first to fifth sections 210, 212, 214, 216, and 218) that are formed by the connecting component 202a, the delivering component 202b, the swirling component 202c, and the central channel component 202d. A gas channel 208 (e.g., a streamlined gas channel along the second example spray device 200) of the second example spray device 200 includes one or more of four sections (e.g., 230, 232, 234, 236) that are formed by the connecting component 202a, the delivering component 202b, the central channel component 202d, and the second housing structure 204.

In some implementations, the liquid channel 206 further includes the first liquid channel section 210 formed by the connecting component 202a. The first liquid channel section 210 is connected to an external input pipe or tube (not shown in FIG. 2A) for liquid feeding. It is optional that the gas channel 208 encloses or discloses the first liquid channel section 210. The second liquid channel section 212 is formed by the delivering component 202b. The second liquid channel section 212 has a constant cross-sectional area and acts as a straight tube. In some implementations, the liquid channel 206 further includes the second liquid channel section 212 used to condition an uneven liquid flow from the external pipe or tube into an even flow before feeding into the swirling component 202c.

In some implementations, the liquid channel 206 includes the third and fourth liquid channel sections 214 and 216 (discussed below in reference to FIGS. 2B-2C) in which the swirling component 202c is optionally disposed. For example, the swirling component 202c includes a plurality of recess channels 214b. The swirling component 202c further includes an incoming channel portion 214a and an exit path 214c. The swirling component 202c is configured to guide a liquid flow 250 into the incoming channel portion 214a, split the liquid flow 250 into a plurality of sideway flows 252 running in the plurality of recess channels 214b, guide the plurality of sideway flows 252 towards the exit path 214c, and form the swirling liquid stream 254 that is substantially stable when exiting the exit path 214c. In some implementations, the third liquid channel section 214 include the incoming channel portion 214a and the plurality of recess channels 214b. In some implementations, the fourth liquid channel section 216 is part of the exit path 214c. The fifth liquid channel section 218 is formed by the central channel component 202d. In some implementations, the fifth liquid channel section 218 includes a contracting cone-shaped portion (not shown in FIG. 2A) that connects the fourth and fifth liquid channel sections 216 and 218. The fifth liquid channel section 218 further includes a first outlet 240 (in reference to FIG. 2B). In addition, the fifth liquid channel section 218 enables the liquid flow to form a conical liquid spray 256 (in reference to FIG. 2B) after exiting the liquid channel 206 from the first outlet 240.

In some implementations, the gas channel 208 includes the first gas channel section 230 formed by the connecting component 202a and the delivering component 202b. The first gas channel section 230 is connected to an external input pipe or tube (not shown in FIG. 2A) for air feeding. It is optional that the first gas channel section 230 is oriented parallel or at an angle to the central axis 280 of the second example spray device 200. In some implementations, the gas channel 208 includes the second gas channel section 232, which is formed by the delivering component 202b and serves as a distributor fixing the gas channel 208 at a middle location of the second example spray device 200. In particular, the second gas channel section 232 includes a plurality of air holes evenly distributed surrounding the second gas channel section 232. Parameters of the air holes (e.g., air hole size, air hole length, number of air holes, etc.) are determined based on design specifications (e.g., cross-sectional area for the air flow) of the aerospike dry fog nanojet spray device. This is to ensure sufficient air pressure for the air flow to pass through the gas channel 208. In addition, cross-sections of the air holes can be circular or in other shapes.

In some implementations, the gas channel 208 includes the third and fourth gas channel sections 234 and 236 (in reference to FIG. 2B), which are formed by the central channel component 202d and the second housing structure 204. The third gas channel section 234 has a constant cross-sectional area and acts as a straight tube. Specifically, the third gas channel section 234 is used to ensure an even air flow before feeding into the fourth gas channel section 236. The fourth gas channel section 236, similar to the tapered section 110 of the first example spray device 100, is coupled with internal and external conical walls or curved (e.g., tapered) walls to increase speed of the air flow. The fourth gas channel section 236 further includes a second outlet 242 (in reference to FIG. 2B), which acts as a circular or ring-shaped orifice and forms a supersonic aerospike air stream 258 (e.g., a supersonic gas jet, in reference to FIG. 2B). A diameter of the second outlet 242 is determined such that a converging aerospike mixture 260 can be formed outside the second outlet 242. In some implementations, the second outlet 242 does not need to be circular and can take on various other shapes.

Additionally, in some implementations, the second example spray device 200 further includes a mixing section 270, which is formed by the second housing structure 204. The mixing section 270 is located at a downstream of the first outlet 240 and the second outlet 242. The mixing section 270 further includes a cylindrical wall 272 and a conical wall 274. On one hand, the cylindrical wall 272 of the mixing section 270 allows for a sufficient mixture of the conical liquid spray 256 and the supersonic aerospike air stream 258, breaking the conical liquid spray 256 into droplets to form a supersonic liquid mist. On the other hand, the conical wall 274 allows the supersonic liquid mist to expand without interference. In some implementations, the mixing section 270 creates at least part of an aerospike zone and a supersonic zone.

Referring to FIG. 2B, in some implementations, the liquid channel 206 is symmetric (e.g., centrally located) with respect to the central axis 280 of the second example spray device 200. Moreover, the gas channel 208 is coaxially arranged surrounding the liquid channel 206, thereby enclosing a substantial portion of the liquid channel 206. Furthermore, a design of making long liquid and gas channels (e.g., the liquid and gas channels 206 and 208 as shown in FIG. 2B) ensures an even distribution of liquid and air discharges for generating consistent droplet sizes. In some implementations, the delivering component 202b and the second housing structure 204 are coupled to one another using threaded connections along a common interface 285.

FIG. 2C illustrates a top view 220 of the swirling component 202c looking along an opposite direction of a Z-axis. FIG. 2C further illustrates a bottom view 222 of the swirling component 202c looking along the Z-axis. The swirling component 202c includes the incoming channel portion 214a, the plurality of recess channels 214b, and the exit path 214c. The swirling component 202c is configured to guide the liquid flow 250 into the incoming channel portion 214a, split the liquid flow 250 into the plurality of sideway flows 252 running in the plurality of recess channels 214b, guide the plurality of sideway flows 252 towards the exit path 214c, and form the swirling liquid stream 254 that is substantially stable in the exit path 214c. In addition, the plurality of recess channels 214b cuts through the swirling component 202c along the Z axis.

In some implementations, the exit path 214c further includes two side channels 224 and an exit channel portion 226. The side channels 224 of the exit path 214c are used to guide the plurality of sideway flows 252 from the plurality of recess channels 214b to the exit channel portion 226 of the exit path 214c. In some implementations, the exit channel portion 226 of the exit path 214c includes, or is coupled to, the fourth liquid channel section 216.

In some implementations, the plurality of side channels 224 is formed under, and extended substantially in parallel to, a top surface 228 of the swirling component 202c that is configured to face the liquid flow 250. As shown in the top view 220 of the swirling component 202c, the plurality of side channels 224 is extended in a X-Y plane, parallel to the top surface 228 of the swirling component 202c.

In some implementations, the exit channel portion 226 is connected to the plurality of side channels 224 and extends along a flow direction (e.g., along an X-axis) of the liquid flow 250 and perpendicular to the plurality of recess channels 214b (e.g., along the Z-axis). Specifically, as shown in the bottom view 222 of the swirling component 202c, the exit channel portion 226 of the exit path 214c is connected to the plurality of side channels 224 to receive the plurality of sideway flows 252.

In some implementations, the swirling component 202c is configured to touch a plurality of locations of an internal wall of the first housing structure that forms the liquid channel 206, and has a plurality of recesses 292 (e.g., cut-offs) from the internal wall of the first housing structure, which are configured to split the liquid flow. For instance, as shown in the top view 220 and bottom view 222 of the swirling component 202c, the swirling component 202c touches two locations 290 of an internal wall of the first housing structure 202 and has two recesses 292 from the internal wall of the first housing structure 202. This structure forms two recess channels 214b for splitting the liquid flow 250.

In some implementations, side channels 224 of a swirling component 202c may be formed in a regular or irregular shape. In some implementations, side channels 224 of a swirling component 202c are configured to uniformly split a liquid flow. In one example, the side channels 224 are radially symmetric with respect to a central axis of the swirling component. For instance, as shown in FIG. 2C the swirling component 202c includes two recess channels 214b that are radially symmetric with respect to the central axis 280. In another example, the side channels 224 may include four channels (e.g., which are radially symmetric with respect to a central axis (e.g., the central axis 280)) of a swirling component 202c.

In some implementations, a width of a side channel 224 is substantially the same as a diameter of an exit channel portion 226. For instance, as shown in the bottom view 222 of the swirling component 202c, the width (Wₜᵤₙₙₑₗ) of the side channel 224 of the exit channel portion 226 is substantially the same as a diameter (D_{central}) of the exit channel portion 226 of the exit path 214c. In some implementations, design of the side channel 224 of the exit path 214c may vary in order to optimize a liquid flow. As a result, a width of a side channel 224 of the exit path 214c may be different from a diameter of an exit channel portion 226

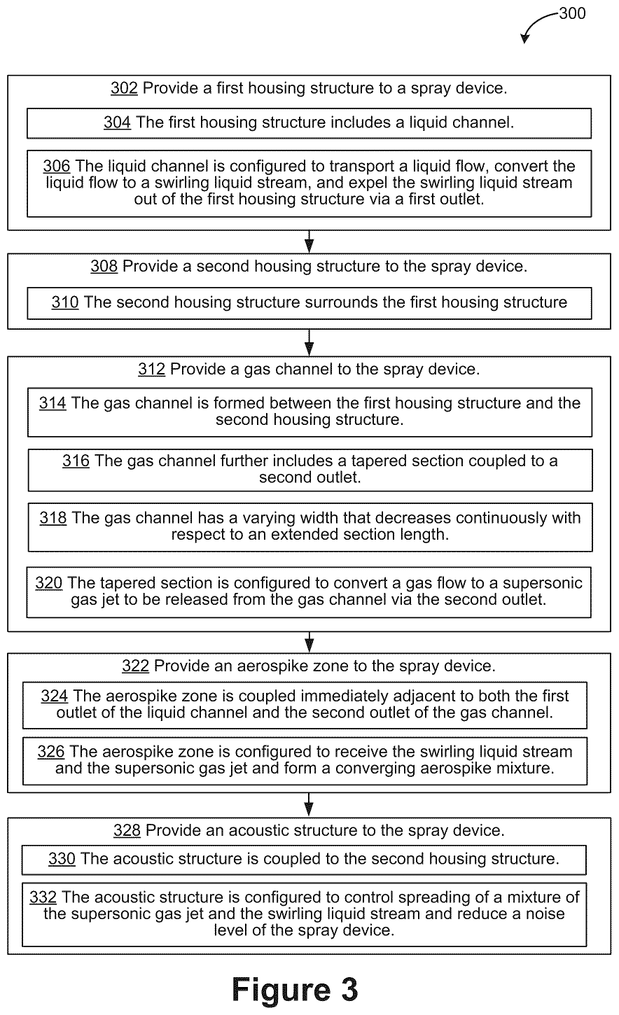

FIG. 3 is a flow diagram of an example method 300 of providing a spray device, in accordance with some implementations. Specifically, the flow diagram of FIG. 3 can be used to provide an aerospike dry fog nanojet spray device described above in reference to FIGS. 1A-2C. The method of 300 includes providing (302) a first housing structure to a spray device. The first housing structure includes (304) a liquid channel. The liquid channel is configured (306) to transport a liquid flow, convert the liquid flow to a swirling liquid stream, and expel the swirling liquid stream out of the first housing structure via a first outlet. The method of 300 also includes providing (308) a second housing structure to the spray device. The second housing structure surrounds (310) the first housing structure. The method of 300 further includes providing (312) a gas channel to the spray device. The gas channel is formed (314) between the first housing structure and the second housing structure. The gas channel further includes (316) a tapered section coupled to a second outlet. The tapered section has (318) a varying width that decreases continuously with respect to an extended section length. The tapered section is configured (320) to convert a gas flow to a supersonic gas jet to be released from the gas channel via the second outlet. The method of 300 further includes providing (322) an aerospike zone to the spray device. The aerospike zone is coupled (324) immediately adjacent to both the first outlet of the liquid channel and the second outlet of the gas channel. The aerospike zone is configured (326) to receive the swirling liquid stream and the supersonic gas jet and form a converging aerospike mixture. The method of 300 further includes providing (328) an acoustic structure to the spray device. The acoustic structure is coupled (330) to the second housing structure. The acoustic structure is configured (332) to control spreading of a mixture of the supersonic gas jet and the swirling liquid stream and reduce a noise level of the spray device.

In some implementations, an external surface of the first housing structure is conical and has a first opening angle, and an internal surface of the first housing structure is conical and has a second opening angle greater than the first opening angle. In some implementations, the gas channel is formed between the external surface of the first housing structure and an internal surface of the second housing structure and configured to increase a gas flow speed of the gas flow.

In some implementations, the second outlet of the gas channel has a ring shape and substantially surrounds the first outlet of the liquid channel, and a width of the second outlet of the gas channel is in a predetermined width range. It is noted that in some implementations, the second outlet of the gas channel is not limited to the ring shape and has a different shape from the ring shape. In some implementations, the predetermined width range is greater than 0.01 mm.

In some implementations, an aerospike zone is coupled immediately adjacent to both the first outlet of the liquid channel and the second outlet of the gas channel. The aerospike zone is configured to receive the swirling liquid stream and the supersonic gas jet and form a converging aerospike mixture. Further, in some implementations, the second housing structure further comprises an expansion portion extending beyond the second outlet of the gas channel. The expansion portion is configured to constrain the converging aerospike mixture in the aerospike zone adjacent to the first outlet and the second outlet. Additionally, in some implementations, a droplet size of liquid droplets of the converging aerospike mixture is in a range of 0.05-50 μm.

In some implementations, an acoustic structure is coupled to the second housing structure. The acoustic structure is configured to control spreading of a mixture of the supersonic gas jet and the swirling liquid stream and reduce a noise level of the spray device. Further, in some implementations, the acoustic structure has a serration edge.

In some implementations, the first housing structure further comprises a swirling component disposed within the liquid channel and adjacent to the first outlet of the liquid channel. The swirling component includes a plurality of side channels. The swirling component is configured to split the liquid flow into a plurality of sideway flows running in the plurality of side channels, guide the plurality of sideway flows towards an exit channel portion, and form the swirling liquid stream that is substantially stable in the exit channel portion. Further, in some implementations, the plurality of side channels is formed under, and extended substantially in parallel to, a top surface of the swirling component that is configured to face the liquid flow. The exit channel portion is connected to the plurality of side channels and extends along a flow direction of the liquid flow and perpendicular to the plurality of side channels. Additionally, in some implementations, the swirling component is configured to touch a plurality of locations of an internal wall of the first housing structure that forms the liquid channel. The swirling component has a plurality of recesses from the internal wall of the first housing structure, which are configured to split the liquid flow.

In some implementations, the plurality of side channels includes two identical side channels that are aligned to each other and meet at the exit channel portion. In some implementations, the plurality of side channels meets at the exit channel portion and have identical geometric features (e.g., length, width, shape).

In some implementations, the extended section length of the tapered section of the gas channel is in a predetermined length range, a taper width of the tapered section of the gas channel is in a predetermined width range, and a volumetric flow rate of the gas channel is in a predetermined flow rate range. In some implementations, the predetermined length range is greater than 1 mm. In some implementations, the predetermined width range is greater than 0.01 mm. In some implementations, the predetermined flow rate range is greater than 10 liters per minute (L/min). It is noted that different ranges used in the description of the various described implementations herein is for the purpose of describing particular implementations only and is not intended to be limiting. One of ordinary skill in the art would recognize that in other implementations ranges different from those discussed in this application may also be feasible to enable an aerospike dry fog nanojet spray as claimed.

In some implementations, the spray device has a plurality of cross sections that are perpendicular to, and intersect with, a central axis, and each cross section is symmetric with respect to a respective intersecting node with the central axis.

In some implementations, the first housing structure further comprises a delivering portion providing a gas incoming region and a gas channel section. The gas channel section is coupled to the second housing structure and has a plurality of air holes coupling the gas incoming region to the gas channel.

In some implementations, the gas channel further includes a straight section that is coupled to the tapered section and has a substantially constant cross-sectional area. The straight section is configured to deliver the gas flow having a substantially constant flow rate to the tapered section.

It should be understood that the particular order in which the operations in FIG. 3 have been described are merely exemplary and are not intended to indicate that the described order is the only order in which the operations could be performed. One of ordinary skill in the art would recognize various ways to manufacturing aerospike dry fog nanojet spray devices as described herein. It is also noted that more details on the method of manufacturing aerospike dry fog nanojet spray devices are explained above with reference to FIGS. 1A-2C. For brevity, these details are not repeated in the description herein.

It will also be understood that, although the terms first, second, etc. are, in some instances, used herein to describe various elements, these elements should not be limited by these terms. These terms are only used to distinguish one element from another. For example, a first spray device can be termed a second spray device, and, similarly, a second spray device can be termed a first spray device, without departing from the scope of the various described implementations. The first spray device and the second spray device are both devices, but they are not the same device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The above description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A spray device, comprising:
a first housing structure including a liquid channel, wherein the liquid channel is configured to transport a liquid flow, convert the liquid flow to a swirling liquid stream, and expel the swirling liquid stream out of the first housing structure via a first outlet;
a second housing structure surrounding the first housing structure; and
a gas channel formed between the first housing structure and the second housing structure, wherein the gas channel further includes a tapered section coupled to a second outlet, and the tapered section has a varying width that decreases continuously with respect to an extended section length, and is configured to convert a gas flow to a supersonic gas jet to be released from the gas channel via the second outlet.

2. The spray device of claim 1, wherein an external surface of the first housing structure is conical and has a first opening angle, and an internal surface of the second housing structure is conical and has a second opening angle greater than the first opening angle.

3. The spray device of claim 2, wherein the gas channel is formed between the external surface of the first housing structure and an internal surface of the second housing structure and configured to increase a gas flow speed of the gas flow.

4. The spray device of claim 1, wherein the second outlet of the gas channel has a ring shape and substantially surrounds the first outlet of the liquid channel, and a width of the second outlet of the gas channel is in a predetermined width range.

5. The spray device of claim 1, further comprising:
an aerospike zone coupled immediately adjacent to both the first outlet of the liquid channel and the second outlet of the gas channel, the aerospike zone is configured to receive the swirling liquid stream and the supersonic gas jet and form a converging aerospike mixture.

6. The spray device of claim 5, wherein the second housing structure further comprises an expansion portion extending beyond the second outlet of the gas channel, and the expansion portion is configured to constrain the converging aerospike mixture in the aerospike zone adjacent to the first outlet and the second outlet.

7. The spray device of claim 6, wherein a droplet size of liquid droplets of the converging aerospike mixture is in a range of 0.05-50 μm.

8. The spray device of claim 1, further comprising:
an acoustic structure coupled to the second housing structure, the acoustic structure configured to control spreading of a mixture of the supersonic gas jet and the swirling liquid stream and reduce a noise level of the spray device.

9. The spray device of claim 8, wherein the acoustic structure has a serration edge.

10. The spray device of claim 1, the first housing structure further comprising a swirling component disposed within the liquid channel and adjacent to the first outlet of the liquid channel, wherein the swirling component includes a plurality of side channels, and is configured to split the liquid flow into a plurality of sideway flows running in the plurality of side channels, guide the plurality of sideway flows towards an exit channel portion, and form the swirling liquid stream that is substantially stable in the exit channel portion.

11. The spray device of claim 10, wherein the plurality of side channels is formed under, and extended substantially in parallel to, a top surface of the swirling component that is configured to face the liquid flow, and the exit channel portion is connected to the plurality of side channels and extends along a flow direction of the liquid flow and perpendicular to the plurality of side channels.

12. The spray device of claim 10, wherein the swirling component is configured to touch a plurality of locations of an internal wall of the first housing structure that forms the liquid channel, and has a plurality of recesses from the internal wall of the first housing structure, which are configured to split the liquid flow.

13. The spray device of claim 10, wherein the plurality of side channels includes two identical side channels that are aligned to each other and meet at the exit channel portion.

14. The spray device of claim 10, wherein the plurality of side channels meets at the exit channel portion and have identical geometric features.

15. The spray device of claim 1, wherein the extended section length of the tapered section of the gas channel is in a predetermined length range, a taper width of the tapered section of the gas channel is in a predetermined width range, and a volumetric flow rate of the gas channel is in a predetermined flow rate range.

16. The spray device of claim 1, wherein the spray device has a plurality of cross sections that are perpendicular to, and intersect with, a central axis, and each cross section is symmetric with respect to a respective intersecting node with the central axis.

17. The spray device of claim 1, wherein the first housing structure further comprises a delivering portion providing a gas incoming region and a gas channel section, and the gas channel section is coupled to the second housing structure and has a plurality of air holes coupling the gas incoming region to the gas channel.

18. The spray device of claim 1, wherein the gas channel further includes a straight section coupled to the tapered section and having a substantially constant cross-sectional area, and the straight section is configured to deliver the gas flow having a substantially constant flow rate to the tapered section.

19. A method for providing a spray device, comprising:
providing a first housing structure including a liquid channel, wherein the liquid channel is configured to transport a liquid flow, convert the liquid flow to a swirling liquid stream, and expel the swirling liquid stream out of the first housing structure via a first outlet;
providing a second housing structure surrounding the first housing structure; and
providing a gas channel formed between the first housing structure and the second housing structure, wherein the gas channel further includes a tapered section coupled to a second outlet, and the tapered section has a varying width that decreases continuously with respect to an extended section length, and is configured to convert a gas flow to a supersonic gas jet to be released from the gas channel via the second outlet.

20. A method for generating nanojet spray, comprising:
transporting a liquid flow in a liquid channel of a first housing structure;
converting the liquid flow to a swirling liquid stream;
expelling the swirling liquid stream out of the first housing structure via a first outlet of the liquid channel; and
converting a gas flow to a supersonic gas jet to be released from a gas channel via a second outlet of the gas channel, wherein the gas channel is formed between the first housing structure and a second housing structure that surrounds the first housing structure, and includes a tapered section coupled to the second outlet, and the tapered section has a varying width that decreases continuously with respect to an extended section length.
